(19) United States
(12) Patent Application Publication
(10) Pub. No.: US 2005/0113023 A1
(43) Pub. Date: May 26, 2005

(54) Method of managing communications in a network and the corresponding signal, transmitting device and destination terminal

(76) Inventors: Antoine Bassompiere, Paris (FR); Nathalie Goudard, Courbevoie (FR)

Correspondence Address: WESTMAN CHAMPLIN & KELLY, P.A., SUITE 1600 - INTERNATIONAL CENTRE, 900 SECOND AVENUE SOUTH, MINNEAPOLIS, MN, 55402-3319, US

(21) Appl. No.: 10/501,200

(22) PCT Filed: Jan. 7, 2003
(86) PCT No.: PCT/FR03/00030

(30) Foreign Application Priority Data
Jan. 10, 2002 (FR) 02/00281

(51) Int. Cl. H04B 7/14

(52) U.S. Cl. 455/20; 455/21; 455/509; 455/522; 455/69

(57) ABSTRACT

An embodiment of the invention relates to the management of communications in a communication network comprising at least one transmitting device and at least one terminal which is adapted to receive data. The inventive management method comprises the following steps: establishment of a communication between one of the terminals, called the destination terminal, and one of the transmitting devices, called the transmitting device, using a first communication mode which is based on a single-carrier modulation; and passing to a second communication mode using a multicarrier modulation, with a communication channel that uses the multicarrier modulation being assigned to the communication between the transmitting device and the destination terminal. According to the inventions, said first and second communication modes are carried out successively in an alternating manner. The invention also relates to the corresponding signal, transmitting device and destination terminal.

This invention relates to the field of telecommunications. More precisely, the invention relates to data transmission and methoding, particularly in a cellular network, and particularly at high-speeds.

Third generation and more recent radiotelephony systems already handle or will handle many services and applications requiring very high-speed data transmissions. Resources allocated to data transfers (for example files containing sound, and/or fixed or animated images), particularly through the Internet or similar networks, will account for an overwhelming part of the available resource and will probably eventually exceed resources allocated to voice communications which should remain approximately constant.

However, the total throughput available to radiotelephony terminal users is limited by the number of available frequencies. One particular method traditionally used to enable sufficient availability of resources is to increase the density of cells in a given territory. The result is thus a network infrastructure divided into “micro-cells” that are relatively small cells. One disadvantage of such a technique is that it requires a large number of fixed stations (base station (BS), called Node B stations according to the UMTS standard), that are relatively complex and expensive elements. Furthermore, although the possible data throughput is high, it is not optimum. Furthermore, at a higher level, it is clear that management becomes more complex as the number of cells, and therefore the number of stations becomes larger.

The capacity of third generation UMTS (Universal Mobile Telecommunication System) networks is also limited by interference between adjacent cells or networks.

Moreover, like all existing radiotelephony systems, third generation systems currently under development are based on a symmetric structure. Thus, the UMTS standard defined by the 3GPP (Third generation Partnership Project) uses a symmetric distribution for the FDD (Frequency Division Duplex) main link, between the downlink channel (base station to terminal) and the uplink channel (terminal to base station). There is also a TDD (Time Division Duplex) link enabling some asymmetry. However, the asymmetry thus available is limited considering the needs of users for Internet type high-speed services, with or without mobility, on the downlink channel.

One solution then consists of using multi-carrier modulations (implemented on a secondary channel) with the W-CDMA (Wide-Code Division Multiple Access, implemented on a main channel). For example, an OFDM (Orthogonal Frequency Division Muplex) channel could be introduced, on a secondary high-speed downlink channel, and shared by all the user equipment of a same cell (as described particularly in patent FR-98 04883 filed on Apr. 10, 1998 by the Wavecom Company). This technique from the prior art has the disadvantage of presenting disturbances between OFDM signals and single carrier signals for a user equipment. Moreover the changeover from signalling data from the main channel to the secondary channel is not optimized and uses unnecessarily bandwidth from the secondary channel. Furthermore, the implementation of this technique is relatively complex and thus expensive, a user equipment having to be adapted to receive data on the secondary downlink channel and, simultaneously, to transmit data on the main uplink channel.

The various aspects of the invention are intended to overcome these disadvantages in prior art.

More precisely, one purpose of the invention is to provide a new communication management technique enabling high-speed data transmission to terminal, for example mobile radiotelephone type terminal.

Another purpose of the invention is to provide such a technique that is compatible with known mobile radio communication standards and particularly the UMTS standard.

Another purpose of the invention is to provide such a technique that optimises the use of available resource in time and in frequency, and that is based on a transmission method particularly well adapted to high-speed data transmission.

Another purpose of the invention is to provide such a technique that enables relatively simple and therefore relatively inexpensive implementation of user terminal.

Another purpose of the invention is to provide such a technique enabling high-speed data reception, even under unfavourable reception conditions (particularly for a high user terminal travel speed, for example of the order of at least 250 km/h, and/or under reception conditions with multiple paths).

Another purpose of the invention is to optimise data transmission, particularly by enabling a global increase in the throughput in one or several networks covering the same geographic area or adjacent areas.

The invention achieves these purposes by proposing a communication management method in a communication network comprising at least one transmission device and at least one terminal adapted to receiving data from at least one of the transmission devices, remarkable in that it includes the following steps:
setting up a communication between one of the transmission devices called the transmission device and one of the terminal, called the receiving terminal, using a first communication mode based on a single carrier modulation; and
changeover to a second communication mode using a multiple carrier modulation, a communication channel using the multiple carrier modulation being assigned to the communication between the transmission device and the receiving terminal;
the first and second communication modes being implemented successively and alternately.

According to one particular characteristic, the method is remarkable in that the modulation is an OFDM type modulation with a guard interval.

According to one particular characteristic, the method is remarkable in that the modulation is an IOTA type modulation.

Thus, the invention enables use of modulation with multiple carriers, particularly of the OFDM type with a guard interval or IOTA, an IOTA type modulation being particularly suitable for high-speed data transmission, particularly under poor transmission/reception conditions (for example in the presence of very noisy radio channel subject to the Doppler effect).

Note that the IOTA (Isotropic Orthogonal Transform Algorithm) type modulation is defined in patent FR-95 05455 filed on May 2, 1995. In particular, the IOTA modulation is based on a multi-carrier signal that will be transmitted to a digital receiver corresponding to frequency multiplexing of several elementary carriers, each corresponding to a series of symbols, two consecutive symbols being separated by symbol time τ₀, the separation ν₀ between two adjacent carriers being equal to half of the inverse of the symbol time τ₀, and each carrier being affected by a spectrum shaping filtering with a band width greater than twice the spacing between carriers ν₀, filtering being chosen such that each symbol is necessarily concentrated in the time domain and in the frequency domain.

According to one particular characteristic, the method is remarkable in that the first communication mode is adapted to carrying out operations for management of setting up, maintaining and closing of a communication between the transmission device and the receiving terminal.

Thus, the first mode is particularly suitable for management of communication without the need for high throughput.

According to one particular characteristic, the method is remarkable in that the communication network is a mobile communication network (UMTS).

According to one particular characteristic, the method is remarkable in that the first communication mode uses at least one common channel that will be used for all terminal managed by the transmission device.

Thus, the use of at least one common channel in particular enables a relatively short communication setting up time for the high-speed data transmission (which is not the case if a dedicated channel is used).

Moreover, it is much easier to implement at least one common channel in the first communication mode than to implement a dedicated channel. In particular, if one or several common channels are used for the first communication mode, there is no need to implement a handover procedure when changing over to an OFDM mode, whereas use of a dedicated channel would make it necessary to use such a procedure or to include two receivers (each being assigned to one of the modes) within the reception terminal.

Moreover, the use of a first communication mode using at least one common channel makes it possible to avoid disturbances between a channel intended particularly for setting up a communication (for example based on the use of a WCDMA (Wide Code Division Multiple Access) type access and a channel enabling high-speed data transmission (for example based on an OFDM modulation).

This characteristic also enables a wider choice in frequency ranges that can be used for the second communication mode.

According to one particular characteristic, the method is remarkable in that the first communication mode uses at least one access channel type (FACH) downlink common channel, enabling the changeover to the second communication mode.

In this way, the invention is advantageously used in a UMTS network, the first communication mode using common channels, for example a FACH type downlink common channel defined in the standard.

According to one particular characteristic, the method is remarkable in that the first communication mode uses at least one uplink common channel (RACH) to acknowledge data transmitted correctly to the reception terminal when the second communication mode is being used.

According to one particular characteristic, the method is remarkable in that the second communication mode is adapted to transmitting data at high-speed between the transmission device and the reception terminal.

According to one particular characteristic, the method is remarkable in that the second communication mode is adapted to transmitting internet type data to the reception terminal.

Thus, since the second transmission mode is particularly well adapted to high-speed data transmission, particularly in the downlink direction, the invention may be reliably and efficiently applied for transmission of internet type data (e-mail, viewing web sites, file, image and/or sound transfers, etc.)

According to one particular characteristic, the method is remarkable in that the transmission device is a base station in a cellular communication network.

Thus, the invention can be used particularly efficiently within a cellular network, the base station implementing a first relatively low speed communication mode compatible with existing cellular network standards (for example UMTS) and a second communication mode enabling high-speed data transfer in an environment that can be difficult.

The invention also relates to a communication network signal comprising at least one transmission device and at least one terminal adapted to receiving data from the transmission device(s), remarkable in that it includes two communication modes, called the first and second communication modes respectively:
the first communication mode based on a single carrier modulation, being used when setting up a communication between at least one of the transmission devices, called the transmission device, and one of the terminals called the reception terminal; and
the second communication mode using a multiple carrier modulation being used on a communication channel using multiple carrier modulation, assigned to communication between the transmission device and the receiving terminal,
the first and second communication modes being used successively and alternately.

The invention also relates to a transmission device designed for use in a communication network comprising at least one terminal adapted to receiving data from the transmission device,
remarkable in that it includes the following means:
   means of setting up a communication between the transmission device and one of the terminals, called the receiving terminal, using a first communication mode based on a single carrier modulation; and
   means of changing over to a second communication mode using a multiple carrier modulation, a communication channel using the multiple carrier modulation being assigned to communication between the transmission device and the receiving terminal;
the first and second communication modes being used successively and alternately.

The invention also relates to a receiving terminal designed for use in a communication network comprising at least one transmission device, the terminal being adapted to receiving data from the transmission device(s), remarkable in that it includes the following means:
means of setting up a communication between one of the transmission devices, called the transmission device, and the terminal using a first communication mode based on a single carrier modulation; and
means of changing to a second communication mode using a multiple carrier modulation, a communication channel using multiple carrier modulation being assigned to communication between the transmission device and the receiving terminal;
the first and second communication mode being used successively and alternately.

The advantages of the reception terminal, the transmission device and the signal are the same as the advantages of the communication management method, and are not described in more detail.

Other characteristics and advantages of the invention will become clearer after reading the following description of a preferred embodiment given as a simple illustrative and non-limitative example, and the attached drawings among which:

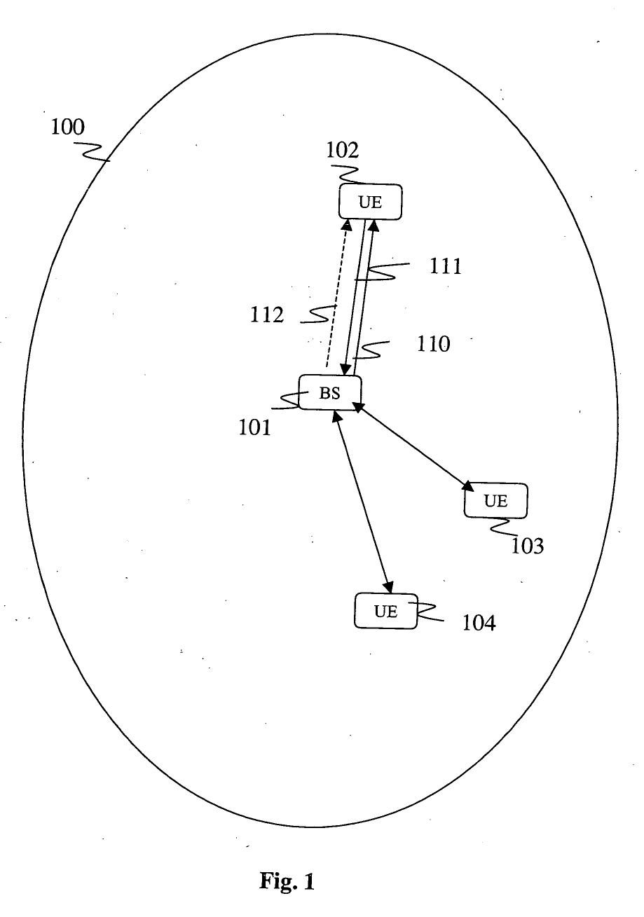

FIG. 1 shows a block diagram of a network according to one particular embodiment of the invention;

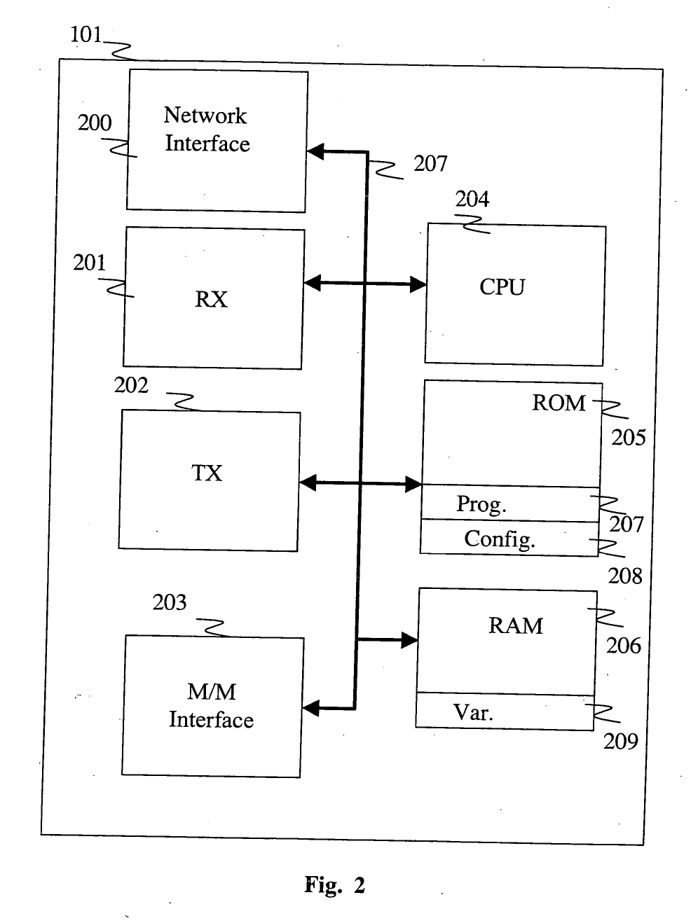

FIG. 2 describes a “micro-cell” base station within the network shown in FIG. 1; and

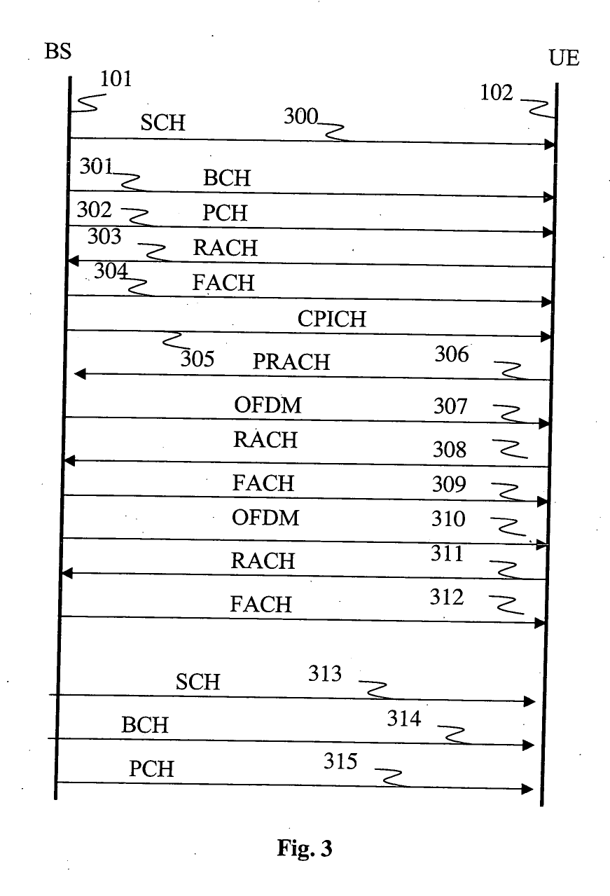

FIG. 3 shows a communication protocol between the different elements in the network in FIG. 1, enabling the changeover from a first communication mode to a second communication mode.

The general principle of the invention is based on changing from a first communication mode using a single carrier modulation to manage communications (setting up, hold and end), for example based on UMTS type channels (particularly the FACH common channel), to a second communication mode based on a multiple carrier modulation (particularly OFDM, for example of the type with guard interval or the IOTA type) to transmit data at high-speed.

According to one particular embodiment of the invention, a terminal can thus use a PRACH channel to make a request to the network to which it belongs, a base station receiving the request then transmitting the response and/or the data on a common channel using an OFDM modulation when the throughput is too high to be carried by the FACH (Forward Access Channel) common channel.

Multiple carrier modulations associated with an error correction code and interlacing have demonstrated their advantages particularly for high-speed transmission in a radio-mobile environment. Therefore, the use of multiple carrier modulation techniques (particularly OFDM with a guard interval or IOTA) is useful when a high spectral efficiency is required and when the channel is strongly non-stationary.

Furthermore, unlike networks compatible with the GSM standard for which a dedicated channel has to be opened for position updates, with the UMTS standard the PRACH channel is the only physical channel used for updating the position. Its speed is limited but it is much higher than GSM, so that this type of solution can be offered without being limited to broadcasting applications.

Therefore, the invention enables the changeover from a first single carrier communication mode to a second multiple carrier communication mode, a multiple carrier channel being preferably assigned to communication between a base station and a terminal and not limited to a broadcasting application concerning several terminals.

Moreover, according to the invention, a terminal can use a PCPCH channel (Physical Common Packet Channel) instead of a PRACH channel, particularly to transmit a request to the data transfer base station, the data then being transmitted at high-speed in the downlink direction using a multiple carrier modulation. An OFDM channel can thus be combined with a PCPCH channel.

Note that user terminal particularly includes mobile or fixed wireless terminal (for example mobile phones or any other type of apparatus (particularly portable computers) comprising a wireless communication system).

FIG. 1 shows a block diagram of a mobile radiotelephony network using the invention.

For example, the network may be compatible with the UMTS (Universal Mobile Telecommunication System) standard defined by the 3GPP committee.

The network includes a cell 100 managed by a base station (BS) 101.

The cell 100 itself includes a base station 101 and terminals (UE) 102, 103 and 104.

Terminals 102, 103 and 104 can exchange data (for an application type layer) and/or signals with the base station 101 through uplink and downlink channels. Thus, terminal 102 and the base station 101 are connected in communication through:
a single carrier downlink channel 110 used for transport of signalling and/or communication control data with the terminal 102;
a single carrier uplink channel 111 also for carrying signalling and/or communication control data; and
a multiple carrier downlink channel 112, for example of the OFDM type, enabling high-speed data transfers from the base station 101 to the terminal 102.

By default, the terminals are in standby mode, in other words in a mode in which they are not in communication mode but are present and available for a communication. In a first communication mode, this terminal is listening in particular to signals sent by the base station 101 on a downlink channel using a single carrier modulation. These signals are sent on:
common transport channels corresponding to services offered to higher communication protocol layers, particularly on BCH (Broadcast Channels) and PCH (Paging Channels); and
common transport channels corresponding to the physical layer of the communication protocol, particularly on CPICH (Common Pilot Channel) channels.

The channels used by third generation (3G) mobile networks are well known to a person skilled in the art of mobile networks and are specified particularly in the “3^{rd} generation Partnership Project; Technical Specification Group Radio Access Network; Physical Channels and mapping of transport channels onto physical channels (FDD) release 1999” standard, reference 3 Gpp.TS25.211 and distributed by the 3GPP publications office. Therefore, these channels will not be described in more detail.

FIG. 2 diagrammatically shows the base station 101 as illustrated with reference to FIG. 1.

The base station 101 includes the following, connected to each other through an address and data bus 207:
a methodor 204;
a RAM 206;
a non-volatile memory 205;
a wired network interface 200 enabling a connection to a fixed infrastructure in the mobile network or to other networks;
a reception radio interface 201 for receiving signals sent by terminals in communication with the base station 101 on dedicated uplink channels;
a radio transmission interface 202 for sending signals using a single carrier modulation or a multi-carrier modulation on dedicated downlink channels and on common transport channels corresponding to the physical layer; and
a man-machine interface 203 for dialogue with the machine for control and maintenance.

The RAM 206 stores data, variables 209 and intermediate methoding results.

The non-volatile memory 205 keeps the following in registers, which are assigned the same name as the data stored in them for convenience:
the operating program of the methodor 204 in a “prog” register 210,
configuration parameters 211 for the base station 101.

Note that one terminal, not shown, includes the following, connected to each other through an address and data bus:
a methodor,
a RAM,
a non-volatile memory,
a radio reception interface to synchronise and in general receive signals sent by the base station 101 in single carrier or multiple carrier modulation;
a radio transmission interface for sending signals in single carrier modulation on dedicated uplink channels and on common uplink transport channels; and
a man-machine interface enabling a dialogue with the machine for control and maintenance.

FIG. 3 shows a communication protocol between the base station 101 and the terminal 102 during communication using a first communication mode with a single carrier modulation and a second communication mode based on the use of a channel assigned to the terminal 102 in multiple carrier modulation.

The base station 101 transmits a signal 300 on the downlink channel SCH to terminals present in the cell 100 and particularly terminal 102. Thus, terminal 102 is synchronised on the SCH channel of the base station 101.

Note that this SCH signal is regularly sent by the base station 101 and that as soon as the synchronisation of terminal 102 is degraded below a given predetermined threshold, it is once again synchronised on the base station 101.

The base station 101 also sends a signal 301 on the BCH channel. This downlink signal indicates which PCH channel the terminal 102 should listen to. Thus, after reception of this signal, the terminal 102 puts itself into listening to the PCH channel indicated by the signal 302.

The base station 101 then sends a signal to the terminal 102 on the PCH channel indicated by the signal 301, this signal being used to detect an incoming call.

Then, assuming that the terminal 102 would like to initialise a communication, it sends a signal 303 on the RACH (Random Access Channel which is a common channel corresponding to a channel access high layer service), this signal 303 indicating to the base station 101 that the terminal 102 is requesting that a communication should be set up.

The base station 101 then sends a communication channel allocation signal 304 on the FACH (Fast Access Channel) that is also a common channel corresponding to a high layer service, according to the first communication mode (with single carrier).

The signals corresponding to the first communication mode are compatible with the first two layers (physical and link) defined in the UMTS standard. According to the invention, at level 3, the base station indicates where, when and how to listen to the OFDM.

The terminal 102 then starts listening to the pilot channel CPICH 305 that, according to the invention, refines synchronisation of the terminal 102.

The communication is then set up between the terminal 102 and the base station 101.

The mobile sends a request through the PRACH uplink channel 306 (physical channel corresponding to the RACH channel) while listening to the FACH channel 304, to obtain the reply from the network, as specified in the existing UMTS-FDD standard. If the network decides that a large amount of information is to be transmitted to the mobile, particularly if the speed available in the FACH channel is too low, the base station 101 informs the terminal 102 through the FACH channel 304 corresponding to the first communication mode, to listen to the OFDM channel associated with the second communication mode.

Thus, according to the invention, the use of a common channel called the OFDM channel using an OFDM modulation is coupled with RACH/FACH common channels (in other words the terminal sends a RACH request and the base station replies with a FACH frame that indicates to the terminal 102 that the data transmission between the base station 101 and the terminal 102 is carried out using a second communication mode with multiple carriers) without changing the physical transmission characteristics of the RACH (uplink channel) and the FACH (downlink channel).

The FACH channel transports signalling information that the mobile uses to listen to the OFDM channel correctly. The FACH indicates when (in other words the start and end time of the block being sent to the terminal), where (in the frequency band, the transmission does not necessarily use the entire available frequency band) and how (Doppler spreading, delay spreading, etc.) to listen to the OFDM channel to receive the data block concerned. By default, the base station uses an OFDM modulation with predetermined characteristics (symbol time, spacing between sub-carriers and distribution of reference symbols or pilot symbols). According to one variant, these characteristics are dynamically optimised by the base station and are adapted as a function of characteristics of the propagation channel.

Thus, the communication between the base station 101 and the terminal 102 changes to a second communication mode that uses a multiple carrier modulation. Thus, the base station 101 transmits data on the OFDM common channel through the signal 307.

The terminal 102 then sends a level 2 acknowledgement on the RACH channel 308.

The terminal then starts listening to the FACH channel 309.

The FACH signal 309, the OFDM signal 310 and the RACH signal 311 similar to signals 304, 307 and 308 respectively, are then exchanged between the base station 101 and the terminal 102. These exchanges may be reiterated depending on the number of data to be transmitted.

According to one variant in which a channel is assigned to the connection between the base station 101 and the terminal 102, data are transmitted in transparent mode 2 without sending the PRACH apart from the initial PRACH request 305 (in other words without acknowledgement).

At the end of the communication, the terminal 102 and/or the base station 101 indicate that the communication is terminated, through the FACH channel 312.

The terminal 102 then returns to standby mode and to the first communication mode based on a single carrier modulation.

The base station 101 then sends signals 313, 314 and 315 on the SCH, BCH and PCH channels respectively, these signals being similar to signals 300, 301 and 302 respectively described above.

According to FIG. 3, use of the OFDM does not require implementation of a “handover”, since cell changes are normally made in CELL-FACH mode between two reception blocks, which is particularly advantageous knowing the difficulty of normalising and implementing the “handover”.

Moreover, since the RACH/FACH channels are used, data could be sent by beam-forming. The terminal 102 could be positioned by means of RACH/FACH channels.

The terminal 102 never receives an OFDM signal at the same time as it emits on a WCDMA FDD type single carrier channel. This very much simplifies the choice of the frequency band to be used for the OFDM channel, given that there is no need to be very far from the FDD uplink channel. Nor is there any simultaneous reception on an OFDM channel and on a WCDMA FDD type single carrier channel (which means that there is no need for a double radio receiver on the terminal 102).

Furthermore, the power control on the OFDM channel no longer needs to be performed continuously as on an FDD channel. However, the network can measure the power at which it receives the RACH to determine the power at which it will send on the OFDM.

Obviously, the invention is not limited to the example embodiments mentioned above.

In particular, a person skilled in the art could make any variant to the type of multiple carrier modulation used. Thus, the modulation could for example be of the OFDM type as described particularly in patent FR-98 04883 filed on Apr. 10, 1998 by the Wavecom Company or an IOTA type modulation defined in patent FR-95 05455 filed on May 2, 1995.

The invention is not limited to UMTS and 3G networks, but can be used for communications between a transmitting station and a terminal, particularly when a high spectral efficiency is required and the channel is highly stationary. Thus, supports for the invention could include land digital radio broadcasting systems for images, sound and/or data or digital communication systems to high throughput mobiles (in mobile networks, radio LANs or transmissions to or from satellites), or for submarine transmissions using an acoustic transmission channel.

There is a wide variety of applications of the invention, and in particular it can be used for high-speed internet type services (if the invention is applied to UMTS, the low throughput of the RACH channel, although it is much higher than in GSM, combined with the very high throughput of the OFDM channel, satisfies the needs of this type of service).

Note that the invention is not limited to a purely physical installation, but it can also be used in the form of a sequence of instructions in a computer program or in any form combining a hardware part and a software part. If the invention is used partially or completely in software form, the corresponding instruction sequence may be but is not necessarily stored on a removable storage means (for example such as a diskette, a CD-ROM or a DVD-ROM), this storage means being partially or completely readable by a computer or a micromethodor.

1. Method for management of communication in a communication network comprising at least one transmission device and at least one terminal adapted to receiving data from the said at least one transmission device wherein the method comprises:
setting up a communication between one of the said transmission devices called the transmission device, and one of the said terminals called the receiving terminal, using a first communication mode based on a single carrier modulation; and
changeover to a second communication mode using a multiple carrier modulation, a communication channel using the said multiple carrier modulation being assigned to the communication between the said transmission device and the said receiving terminal;
the first and second communication modes being implemented successively and alternately.

2. Method according to claim 1, wherein the said multiple carrier modulation is an OFDM type modulation with a guard interval.

3. Method according to claim 1, wherein the said multiple carrier modulation is an IOTA type modulation.

4. Method according to claim 1, wherein the said first communication mode is adapted to carrying out operations for management of setting up, maintaining, and closing of a communication between the transmission device and the receiving terminal.

5. Method according to claim 1, wherein the said communication network is a mobile communication network (UMTS).

6. Method according to claim 5, wherein the said first communication mode uses at least one common channel (FACH) that is intended to all the terminals managed by the said transmission device.

7. Method according to claim 6, wherein the said first communication mode uses at least one access channel type (FACH) downlink common channel, enabling the said changeover to the said second communication mode.

8. Method according to claim 1, wherein the said first communication mode uses at least one uplink common channel (RACH) to acknowledge data transmitted correctly to the said reception terminal when the second communication mode is being used.

9. Method according to claim 1, wherein the said second communication mode is adapted to transmitting data at high speed between the said transmission device and the said reception terminal.

10. Method according to claim 9, wherein the said second communication mode is adapted to transmitting Internet type data to the said reception terminal.

11. Method according to claim 1, wherein the said transmission device is a base station in a cellular communication network.

12. Communication network signal comprising at least one transmission device and at least one terminal adapted to receiving data from the said at least transmission device, wherein the communication network further comprises first and second communication modes:
the first communication mode based on a single carrier modulation, being used when setting up a communication between at least one of the said transmission devices, called the transmission device, and one of the said terminals called the reception terminal; and
the second communication mode using a multiple carrier modulation being used on a communication channel using the said multiple carrier modulation, assigned to communication between the said transmission device and the said receiving terminal,
the first and second communication modes being used successively and alternately.

13. Transmission device designed to be implemented in a communication network comprising at least one terminal adapted to receiving data from the said transmission device, wherein the transmission device comprises:
means of setting up a communication between the said transmission device and a first of the said terminals, called the receiving terminal, using a first communication mode based on a single carrier modulation; and
means of changing over to a second communication mode using a multiple carrier modulation, a communication channel using the said multiple carrier modulation being assigned to communication between the said transmission device and the said receiving terminal;
the said first and second communication modes being used successively and alternately.

14. Receiving terminal that designed to be implemented in a communication network comprising at least one transmission device, the said terminal being adapted to receiving data from the said at least one transmission device, wherein the terminal comprises:
means of setting up a communication between a first of the said transmission devices, called the transmission device, and the said terminal using a first communication mode based on a single carrier modulation; and
means of changing to a second communication mode using a multiple carrier modulation, a communication channel using the said multiple carrier modulation being assigned to communication between the said transmission device and the said receiving terminal;
the said first and second communication modes being used successively and alternately.
